(19) United States
(12) Patent Application Publication
(10) Pub. No.: US 2026/0242270 A1
(43) Pub. Date: Aug. 20, 2026

(54) METALENS, METHOD OF MANUFACTURING METALENS, ELECTRONIC DEVICE, AND METHOD OF DESIGNING METALENS

(71) Applicant: TOHOKU UNIVERSITY, Sendai-shi, Miyagi (JP)

(72) Inventors: Yoshiaki KANAMORI, Sendai-shi (JP); Taiyu OKATANI, Sendai-shi (JP)

(21) Appl. No.: 18/869,738

(22) PCT Filed: Jun. 26, 2023
(86) PCT No.: PCT/JP2023/023619

§ 371 Date: Nov. 26, 2024

(30) Foreign Application Priority Data
Jul. 15, 2022 (JP) 2022-114260

(51) Int. Cl. C03B 11/08; C03C 15/00; G02B 1/02; G02B 3/00; G02B 3/02

(52) U.S. Cl. CPC C03B 11/082; C03C 15/00; G02B 1/02; G02B 3/02; G02B 2003/0093

(57) ABSTRACT

A method of manufacturing a metalens includes a mask pattern forming step of forming a mask pattern on a silicon layer of a substrate provided with the silicon layer on a surface, an etching step of etching the silicon layer to form a silicon pattern layer having an array pattern composed of a plurality of silicon columnar bodies or a plurality of pre-oxidation holes, and an oxidation treatment step of oxidizing at least a part of silicon in the silicon pattern layer to form a pattern layer composed of a plurality of silicon oxide columnar bodies or a plurality of holes. The pattern layer has a focal point for light incident on the pattern layer.

### CROSS-REFERENCE TO RELATED APPLICATIONS

This application is the U.S. National Stage entry of International Application No. PCT/JP2023/023619, filed on Jun. 26, 2023, which, in turn, claims priority to Japanese Patent Application No. 2022-114260, filed on Jul. 15, 2022, both of which are hereby incorporated herein by reference in their entireties for all purposes.

### TECHNICAL FIELD

The present invention relates to a metalens, a method of manufacturing a metalens, an electronic device, and a method of designing a metalens.

### BACKGROUND ART

There is a need for thinner lenses to be used in mobile camera modules. Furthermore, when a lens is heavy, the inertia moment increases. Therefore, in the field of robotics, lightweight lenses are required.

For example, a metalens has been proposed as a thin and lightweight lens. A metalens is an optical element having a fine periodic structure smaller than that of an incident wavelength, and thus, the metalens functions as a lens.

Non-Patent Document 1 discloses a metalens manufactured by forming columnar bodies (pillars) of SiO₂.

### CITATION LIST

### Non-Patent Literature

Non-Patent Document 1: Joon-Suh Park, Shuyan Zhang, Alan She, Wei Ting Chen, Peng Lin, Kerolos M. A. Yousef, Ji-Xin Cheng, and Federico Capasso, “All-Glass, Large Metalens at Visible Wavelength Using Deep-Ultraviolet Projection Lithography”, Nano Letters, Vol. 19, (2019), 8673 to 8682

### SUMMARY OF INVENTION

### Technical Problem

In order to manufacture a metalens having a short focal length, for example, it is effective to reduce the period (center-to-center distance) of columnar bodies. In order to reduce the period of the columnar bodies, columnar bodies having a high aspect ratio are required. In a conventional manufacturing method, for example, in a method of manufacturing a metalens in Non-Patent Document 1, SiO₂ is directly etched to form columnar bodies of SiO₂. SiO₂ has a low etching selectivity. Therefore, when SiO₂ is directly etched in an attempt to form a columnar body having a high aspect ratio, the columnar body is damaged. Thus, in the method of Non-Patent Document 1, it is only possible to form a columnar body having an aspect ratio of up to 6.6, and the focal length increases.

The present invention has been contrived in view of the above-described circumstances and an object thereof is to provide a metalens having a short focal length, a method of manufacturing a metalens, an electronic device, and a method of designing a metalens.

### Solution to Problem

To solve the problems described above, the present invention proposes the following means.
(1) A method of manufacturing a metalens according to a first aspect of the present invention includes
a mask pattern forming step of forming a mask pattern on a silicon layer of a substrate provided with the silicon layer on a surface,
an etching step of etching the silicon layer to form a silicon pattern layer having an array pattern composed of a plurality of silicon columnar bodies or a plurality of pre-oxidation holes, and
an oxidation treatment step of oxidizing at least a part of silicon in the silicon pattern layer to form a pattern layer composed of a plurality of silicon oxide columnar bodies or a plurality of holes, in which
the pattern layer has a focal point for light incident on the pattern layer.
(2) According to a second aspect of the present invention, in the method of manufacturing a metalens according to the first aspect, the oxidation may be a wet oxidation or a dry oxidation.
(3) According to a third aspect of the present invention, the method of manufacturing a metalens according to the first or second aspect may further include,
after the etching step,
a step of annealing the substrate provided with the silicon pattern layer in a hydrogen atmosphere, an argon atmosphere, or a mixed atmosphere of hydrogen and argon.
(4) According to a fourth aspect of the present invention, in the method of manufacturing a metalens according to any one of the first to third aspects, the mask pattern may be composed of a resin, silicon oxide, silicon nitride, or alumina.
(5) According to a fifth aspect of the present invention, in the method of manufacturing a metalens according to any one of the first to third aspects, the mask pattern may be composed of a metal.
(6) According to a sixth aspect of the present invention, in the method of manufacturing a metalens according to any one of the first to fifth aspects,
a maximum value of an aspect ratio of the plurality of silicon oxide columnar bodies or the plurality of holes in the pattern layer may be greater than 6.7.
(7) According to a seventh aspect of the present invention, in the method of manufacturing a metalens according to any one of the first to sixth aspects,
a center-to-center distance between the plurality of silicon columnar bodies may be 1.4 times or more a width of the plurality of silicon columnar bodies.
(8) According to an eighth aspect of the present invention, in the method of manufacturing a metalens according to any one of the first to seventh aspects,
in the etching step, the silicon pattern layer may be etched in consideration of an expansion of the silicon in the oxidation treatment step.
(9) A metalens according to a ninth aspect of the present invention includes, in this order,
a support substrate, and
a pattern layer having an array pattern composed of a plurality of silicon oxide columnar bodies or a plurality of holes, in which
a maximum value of an aspect ratio of the plurality of silicon oxide columnar bodies or the plurality of holes in the pattern layer is greater than 6.7, and
the pattern layer contains at least SiO₂.
(10) According to a tenth aspect of the present invention, in the metalens according to the ninth aspect, the pattern layer may be composed of SiO₂.
(11) According to an eleventh aspect of the present invention, the metalens according to the ninth aspect or the tenth aspect may further include an intermediate layer between the support substrate and the pattern layer.
(12) According to a twelfth aspect of the present invention, in the metalens according to the ninth aspect or the tenth aspect,
the pattern layer may include a folding portion at a location where a phase difference with respect to a center is 360°.
(13) An electronic device according to a thirteenth aspect of the present invention includes the metalens according to any one of the ninth to twelfth aspects.
(14) A method of designing a metalens according to a fourteenth aspect of the present invention is a method of designing a metalens and includes
a phase difference calculation step of calculating a phase difference φ(r) with respect to a distance r from a center of the metalens, based on a set wavelength λ and a set focal length f of incident light,
a columnar body dimension determination step of determining ranges of a height H and a width aₓ, and a period Λₓ of silicon oxide columnar bodies included in the metalens by calculating a relationship between the height H, the width aₓ, and the period Λₓ and a phase difference φ(aₓ) with respect to the width aₓ, and
a columnar body width with respect to distance r calculation step of calculating, after the columnar body dimension determination step, the width aₓ with respect to the distance r from the center of the metalens, from a relationship between the phase difference φ(r) with respect to the distance r and the phase difference φ(aₓ) with respect to the width aₓ, in which
in the phase difference calculation step, when the phase difference φ(r) with respect to the distance r is 360° or greater, φ′(r) is calculated satisfying Equation (A) and Expression (B) below:

φ′(r)=φ(r)−360°×n (A)

φ′(r)<360° (B)
where in Equation (A), n is a natural number.
(15) According to a fifteenth aspect of the present invention, the method of manufacturing a metalens according to any one of the first to eighth aspects may further include a step of performing the method of designing a metalens according to the fourteenth aspect.

### Advantageous Effects of Invention

According to the above-described aspects of the present invention, it is possible to provide a metalens having a short focal length, a method of manufacturing a metalens, an electronic device, and a method of designing a metalens. In particular, it is possible to provide a manufacturing method which exhibits an excellent etching selectivity ratio of Si and a remarkable effect of converting Si into SiO₂ by thermal oxidation.

### BRIEF DESCRIPTION OF DRAWINGS

FIG. 1(a) is an example of a plan view in which a part of an array pattern of a metalens according to a first embodiment is enlarged. FIG. 1(b) is a cross-sectional view taken along line A-A of the metalens in FIG. 1(a).

FIG. 2 is a graph showing a relationship between an equivalent refractive index n2D and an occupancy rate fₓ when incident light has a wavelength of 632.8 nm.

FIG. 3 is a flowchart illustrating a method of designing the metalens according to the first embodiment.

FIG. 4 is a graph showing an example of a calculation result of a phase difference φ with respect to a distance from a lens center.

FIG. 5 is a graph showing another example of a calculation result of the phase difference q with respect to the distance from the lens center.

FIG. 6 is a graph showing an example of a calculation result of a phase difference φ(aₓ) with respect to a width aₓ of a silicon oxide columnar body.

FIG. 7A is a diagram illustrating an example of a pattern model of the designed metalens.

FIG. 7B is a diagram in which a part of the metalens in FIG. 7A is enlarged.

FIG. 7C is a diagram in which a part of the metalens in FIG. 7A is enlarged.

FIG. 8 is a flowchart illustrating a method of manufacturing the metalens according to the first embodiment.

FIG. 9 illustrates cross-sectional views of an example of manufacturing steps in the method of manufacturing the metalens according to the first embodiment. FIG. 9(a) is a diagram illustrating a mask pattern forming step. FIG. 9(b) is a diagram illustrating an etching step. FIG. 9(c) is a diagram illustrating an oxidation treatment step.

FIG. 10(a) is a plan view in which a part of an array pattern of a metalens according to a second embodiment is enlarged. FIG. 10(b) is a cross-sectional view taken along line C-C of the metalens in FIG. 10(a).

FIG. 11 is a graph showing a relationship between a width (nm) of a silicon columnar body and an expansion rate of the width of the columnar body.

FIG. 12 is a schematic view of a focal length evaluation apparatus.

FIG. 13 are graphs showing a relationship between the luminance and a distance r from the lens center, measured while changing the height of the metalens during one hour of oxidation. FIG. 13(a) shows the relationship between the luminance and the distance r from the lens center from Z=0 μm to Z=500 μm. FIG. 13(b) shows the relationship between the luminance and the distance r from the lens center at Z=600 μm. FIG. 13(c) shows the relationship between the luminance and the distance r from the lens center from Z=700 μm to Z=1400 μm.

FIG. 14 illustrates graphs similar to FIG. 13, showing the relationship between the luminance and the distance r from the lens center, measured while changing the height of the metalens during three hours of oxidation.

FIG. 15 is a graph showing a design value W_{d} of a columnar body and a result of linear approximation of a ratio γ between an actual measurement value Wₘₚ of the width of the silicon oxide columnar body and a design value W_{d}.

FIG. 16 is a diagram illustrating a relationship between the luminance and the distance r from the lens center, measured while changing the height of a metalens in Example 2.

### DESCRIPTION OF EMBODIMENTS

### First Embodiment

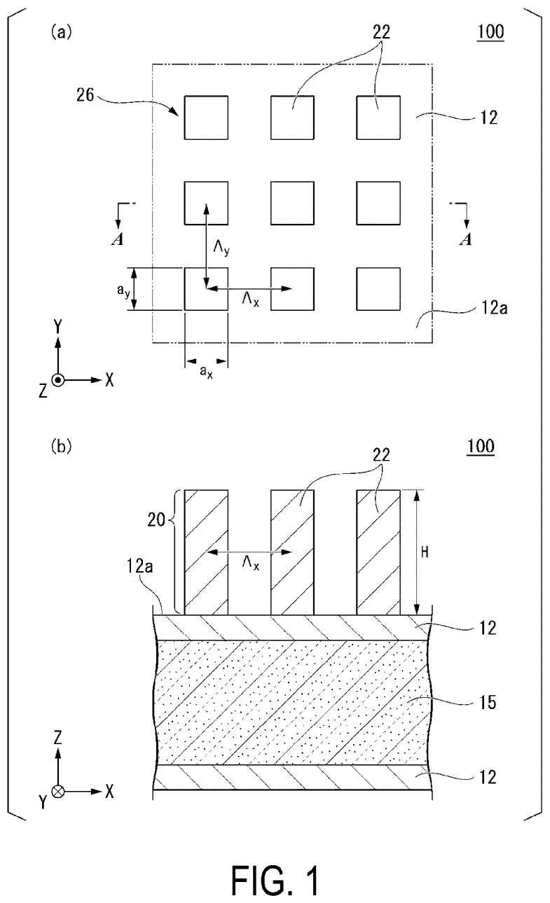

A metalens according to a first embodiment of the present invention will be described below with reference to the drawings. FIG. 1(a) is a plan view in which a part of an array pattern of a metalens 100 according to the first embodiment is enlarged. FIG. 1(b) is a cross-sectional view taken along line A-A of the metalens 100 in FIG. 1(a). The metalens 100 includes a support substrate 15 and a pattern layer 20, in this order. The pattern layer 20 has an array pattern composed of a plurality of silicon oxide columnar bodies 22. The metalens 100 according to the first embodiment is a reflective type metalens that reflects incident light. In the following description, an X direction in the first embodiment is a direction parallel to a front surface 12a of an intermediate layer 12 provided between the support substrate 15 and the pattern layer 20, and is one of directions in which the silicon oxide columnar bodies 22 are arrayed. Note that the front surface 12a and the intermediate layers 12 facing each other with the support substrate 15 interposed therebetween are formed when the support substrate 15 is subjected to a thermal oxidation treatment, and may not affect an optical function of the metalens 100. A Y direction is a direction parallel to the front surface 12a of each of the intermediate layers 12 and a direction intersecting the X direction. For example, the Y direction is substantially orthogonal to the X direction. A Z direction is a thickness direction of the support substrate 15 and is a direction intersecting the X direction and the Y direction. Each constituent element will be described below.

### Support Substrate 15

The material of the support substrate 15 is not particularly limited, as long as the material can form the reflective type metalens 100. For example, silicon (Si) is preferably used as the material of the support substrate 15. The thickness of the support substrate 15 is not particularly limited, as long as the support substrate 15 can hold the pattern layer 20.

### Intermediate Layer 12

The metalens 100 includes the intermediate layer 12 between the support substrate 15 and the pattern layer 20. Specifically, the intermediate layer 12 is provided on the support substrate 15. The material of the intermediate layer 12 is not particularly limited as long as the metalens 100 can function as the reflective type metalens 100. For example, the material of the intermediate layer 12 is silicon dioxide (SiO₂). The thickness of the intermediate layer 12 is also not particularly limited, as long as the metalens 100 can function as the reflective type metalens 100. For example, the thickness of the intermediate layer 12 is from 1 μm to 20 μm. In the metalens 100, incident light passing through the pattern layer 20 is reflected at an interface between the intermediate layer 12 and the support substrate 15.

### Pattern Layer 20

In the first embodiment, the pattern layer 20 is provided on the intermediate layer 12. The pattern layer 20 has an array pattern 26 composed of a plurality of the silicon oxide columnar bodies 22. Here, the array pattern refers to a pattern in which fine structured bodies (for example, the silicon oxide columnar bodies 22) are regularly arranged in the X direction and the Y direction at predetermined intervals (center-to-center distance). The pattern layer 20 contains at least SiO₂. The pattern layer 20 may include Si. The refractive index of Si is higher than that of SiO₂, so that, when the pattern layer 20 is composed of SiO₂ and Si, the equivalent refractive index may be greater than in a case in which the pattern layer 20 is composed of SiO₂. The pattern layer 20 may be composed of SiO₂. If the pattern layer 20 is composed of SiO₂, the transmittance with respect to incident light can be increased, as compared with a case in which the pattern layer 20 is composed of SiO₂ and Si. The pattern layer 20 includes a folding portion at a location where a phase difference is 360° with respect to the center of the metalens 100. The folding portion refers to a location where the phase difference is from 360° to 0° along a radial direction from the center of the metalens 100.

The pattern layer 20 has a focal point for incident light. A focal length of the pattern layer 20 is appropriately set according to the design of the metalens 100. For example, when a wavelength of the incident light is a wavelength of visible light (wavelength: from 400 to 800 nm), the focal length of the pattern layer 20 is, for example, from 500 μm to 2500 μm.

The shape (planar shape) of each of the silicon oxide columnar bodies 22 viewed from the Z direction is not particularly limited, and may be a polygonal shape, a circular shape, or the like. In the first embodiment, the planar shape of the silicon oxide columnar body 22 is a square. A width aₓ in the X direction and a width a_{y} in the Y direction of the silicon oxide columnar body 22 are appropriately set in accordance with the design of the metalens 100. For example, the width aₓ of the silicon oxide columnar body 22 in the X direction is from 150 nm to 600 nm. The width a_{y} of the silicon oxide columnar body 22 in the Y direction is, for example, from 150 nm to 600 nm.

A center-to-center distance (period) Λₓ of the silicon oxide columnar bodies 22 along the X direction and a center-to-center distance (period) Λ_{y} of the silicon oxide columnar bodies 22 along the Y direction, viewed from the Z direction, are appropriately set in accordance with the design of the metalens 100. For example, the period Λₓ of the silicon oxide columnar bodies 22 along the X direction is from 200 nm to 600 nm. The period Λ_{y} of the silicon oxide columnar bodies 22 along the Y direction is, for example, from 200 nm to 600 nm. The period Λₓ and the period Λ_{y} are preferably the same. The center of each of the silicon oxide columnar bodies 22 viewed from the Z direction is the center of the smallest enclosing circle when the planar shape of the silicon oxide columnar body 22 is a polygon, and is the center of a circle when the planar shape is a circle. Here, the smallest enclosing circle is the smallest circle that completely encloses the polygon.

A length (height) H of the silicon oxide columnar body 22 in the Z direction is appropriately set in accordance with the design of the metalens 100. The height H of the silicon oxide columnar body 22 is from 1.0 μm to 3.0 μm.

An aspect ratio (H/aₓ), which is the ratio of the height H of the silicon oxide columnar body 22 to the width aₓ of the silicon oxide columnar body 22 in the X direction, is appropriately set in accordance with the design of the metalens 100. The maximum value of the aspect ratio (H/aₓ) is greater than 6.7. More preferably, the maximum value of the aspect ratio (H/aₓ) is 7.0 or greater. Similarly, the maximum value of an aspect ratio (H/a_{y}), which is the ratio of the height H of the silicon oxide columnar body 22 to the width a_{y} of the silicon oxide columnar body 22 in the Y direction, is also appropriately set in accordance with the design of the metalens 100. The maximum value of the aspect ratio (H/a_{y}) is greater than 6.7. More preferably, the maximum value of the aspect ratio (H/a_{y}) is 7.0 or greater. When the planar shape of the silicon oxide columnar body 22 is a square or a circle, the aspect ratio (H/aₓ) is substantially the same as the aspect ratio (H/a_{y}). That is, in such a case, the aspect ratio of the silicon oxide columnar body 22 is the ratio between the width and the height.

Next, a relationship between the array pattern 26 of the silicon oxide columnar bodies 22 and the lens function will be described. The array pattern 26 of the silicon oxide columnar bodies 22 has a periodic structure that is small with respect to that of the incident wavelength. The periodic structure can be regarded as an optical medium having a uniform refractive index. An equivalent refractive index n_{2D} is expressed by Equation (1) below when n₁ is the refractive index of each of the silicon oxide columnar bodies 22 in FIGS. 1(a) and 1(b), n₂ is the refractive index of a surrounding medium, n_{TE} is the refractive index of a Transverse Electric Wave (TE wave), and n_{TM} is the refractive index of a Transverse Magnetic Wave (TM wave). n_{TE} in Equation (1) is expressed by Equation (2), and n_{TM} in Equation (1) is expressed by Equation (3). In Equation (1), fₓ is an occupancy rate in the X direction and is expressed by Equation (4). In Equation (1), f_{y} is an occupancy rate in the Y direction and is expressed by Equation (5). In Equation (4), aₓ is the width of the silicon oxide columnar bodies 22 in the X direction, and Λₓ is the center-to-center distance (period) of the silicon oxide columnar bodies 22 in the X direction. In Equation (5), a_{y} is the width of the silicon oxide columnar bodies 22 in the Y direction, and Λ_{y} is the center-to-center distance (period) of the silicon oxide columnar bodies 22 along the Y direction.

$$[ Math . 1 ]$$

$${n}_{2 D} = {[ \frac{{f}_{x} * {\overline{n}}_{TE}^{2} + ( 1 - {f}_{x} ) * {n}_{2}^{2}}{{f}_{y} * {\overline{n}}_{TM}^{- 2} + ( 1 - {f}_{y} ) * {n}_{2}^{- 2}} ]}^{\frac{1}{4}} \qquad ( 1 )$$

$${\overline{n}}_{TE}^{2} = {f}_{x} * {n}_{1}^{2} + ( 1 - {f}_{x} ) {n}_{2}^{2} \qquad ( 2 )$$

$${\overline{n}}_{TM}^{- 2} = {f}_{y} * {n}_{1}^{- 2} + ( 1 - {f}_{y} ) {n}_{2}^{- 2} \qquad ( 3 )$$

$${f}_{x} = \frac{{a}_{x}}{{Λ}_{x}} \qquad ( 4 )$$

$${f}_{y} = \frac{{a}_{y}}{{Λ}_{y}} \qquad ( 5 )$$

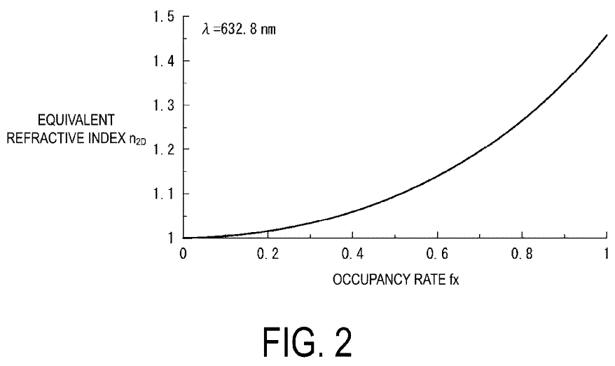

FIG. 2 shows the relationship between the equivalent refractive index n_{2D} and the occupancy rate fₓ when the incident light has a wavelength of 632.8 nm. FIG. 2 shows results obtained in a calculation in which n₁ in Equation (1) above is 1.457, that is, the refractive index of SiO₂, and the refractive index n₂ of the surrounding medium is 1, that is, the refractive index of air. In the first embodiment, the shape is a square, and thus, fₓ=f_{y} is satisfied. In FIG. 2, the vertical axis represents the equivalent refractive index n_{2D}, and the horizontal axis represents the occupancy rate fₓ. As illustrated in FIG. 2, it can be understood that the equivalent refractive index n_{2D} increases when the occupancy rate fₓ is higher. The occupancy rate may be changed to cause a distribution in the equivalent refractive index n_{2D}. By such a refractive index distribution, the metalens 100 can function as a lens. An optical path length used when a light wave is transmitted through the pattern layer 20 is represented by n_{2D}H, which is obtained by multiplying the height H of each of the silicon oxide columnar bodies 22 by the equivalent refractive index n_{2D}.

In the metalens 100 according to the present embodiment, the aspect ratio of the silicon oxide columnar bodies 22 is high, and thus, the focal length can be shortened to, for example, 500 μm to 2500 μm. A specific description will be given later.

In the first embodiment, the metalens 100 includes the intermediate layer 12. However, the metalens 100 may not include the intermediate layer 12, as long as the metalens 100 can reflect incident light.

The metalens 100 according to the first embodiment may be warped.

Furthermore, the silicon oxide columnar bodies 22 are not limited to columnar bodies completely perpendicular to the front surface 12a of the intermediate layer 12. The widths aₓ and a_{y} of each of the silicon oxide columnar bodies 22 are not limited to being uniform, and may be non-uniform with a design error of about 1 to 5%. The aspect ratio of the height H of the silicon oxide columnar bodies 22 with respect to the average widths aₓ and a_{y} may be greater than 6.7.

### Method of Designing Metalens 100

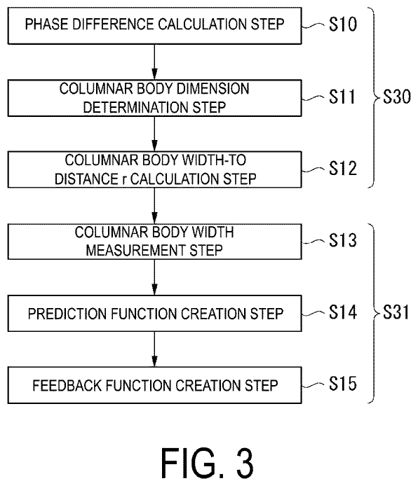

Next, an example of a method of designing the metalens 100 according to the first embodiment will be described. FIG. 3 is a flowchart illustrating a method of designing the metalens 100 according to the first embodiment. Here, a case in which the planar shape of each of the silicon oxide columnar bodies 22 is a square will be described as an example. However, the metalens can be designed by a similar method, even when the silicon oxide columnar body 22 has another planar shape such as a circular shape. Here, the planar shape of the silicon oxide columnar body 22 is a square, and thus, the width aₓ of the silicon oxide columnar body 22 is the same as the width a_{y} of the silicon oxide columnar body 22 in the Y direction. If the planar shape is a circle, the width aₓ is the diameter of the circle. The period Λₓ of the silicon oxide columnar bodies 22 in the X direction is the same as the period Λ_{y} of the silicon oxide columnar bodies 22 in the Y direction.

### Initial Setting Step

The method of designing the metalens 100 includes an initial setting step S30 and a correction step S31. The initial setting step S30 will be described below. The initial setting step S30 includes a phase difference calculation step S10 of calculating a phase difference φ(r) with respect to a distance r as a function of the distance r from the center of the metalens, based on a set wavelength λ of incident light and a set focal length f, a columnar body dimension determination step (dimension determination step) S11 of determining ranges of the height H and the width aₓ, and the period Λₓ of the silicon oxide columnar bodies 22 by calculating a relationship between the height H, the width aₓ, and the period Λₓ, and a phase difference φ(aₓ) with respect to the width aₓ of the silicon oxide columnar bodies 22 constituting the metalens 100, and a columnar body width with respect to distance r calculation step S12 of calculating, after the dimension determination step S11, the width aₓ of each of the columnar bodies with respect to the distance r from the center of the metalens, from the relationship between the phase difference φ(r) with respect to the distance r and the phase difference φ(aₓ) with respect to the width aₓ of the silicon oxide columnar bodies 22. Each calculation step will be described below.

### Phase Difference φ(r) Calculation Step

In the phase difference φ calculation step S10, first, the wavelength of the incident light, the focal length f, and a lens diameter D are set. Here, an example is described in which the incident light has a wavelength λ of 532 nm, the focal length f is 1000 μm, and the lens diameter D is 100 μm. These numerical values can be appropriately changed according to a purpose. The phase difference φ(r) with respect to the distance r (the distance in the radial direction) from the lens center is calculated from Equation (6) below. In Equation (6), λ represents the wavelength of incident light, r represents the distance from the lens center, and f represents the focal length.

$$[ Math . 2 ]$$

$$Φ ( r ) = - \frac{360}{λ} ( \sqrt{{r}^{2} + {f}^{2}} - f ) \qquad ( 6 )$$

Equation (6) indicates that the phase difference φ(x) increases as the focal length f decreases. For example, if the focal length has a large value fa and a small value fb, the phase difference of fb is greater than the phase difference of fa at a distance r1 from the lens center. As described above, the optical path length (that is, the phase difference) is a value obtained by multiplying the height of the silicon oxide columnar body by the equivalent refractive index. Therefore, when the height of the silicon oxide columnar body is higher, the obtained phase difference is greater, so that a short focal length can be obtained.

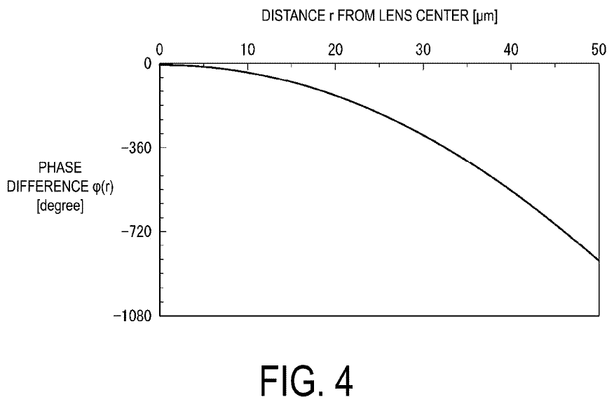

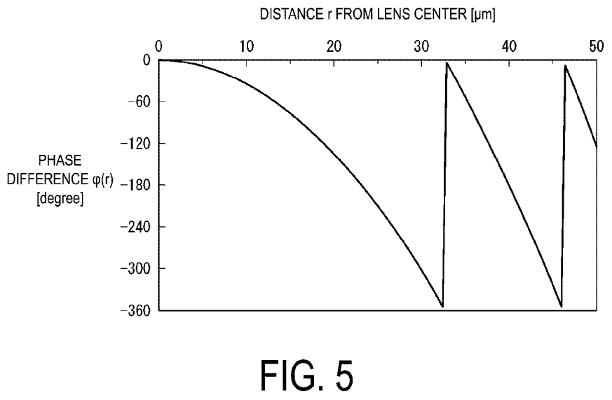

FIG. 4 shows an example of the phase difference φ(r) calculated by using Equation (6) above. In FIG. 4, the horizontal axis represents the distance r (μm) from the lens center, and the vertical axis represents the phase difference (°). In the calculation of the phase difference φ, an equiphase is obtained before and after every 360°, and thus, the phase difference can be folded back. Specifically, as the distance r increases, the phase difference φ(r) increases, and when the phase difference φ(r) is 360° or greater, φ′(r) is calculated so as to satisfy Equation (A) and Expression (B) below. In Equation (A) below, n is any natural number. FIG. 5 shows an example in which the phase difference is folded back every 360°. In FIG. 5, the horizontal axis represents the distance r (μm) from the lens center, and the vertical axis represents the phase difference (°). By setting the phase difference in the metalens 100 in a range from 0° to 360°, the silicon oxide columnar bodies 22 having the same width can be periodically and repeatedly used for the metalens, and the silicon oxide columnar bodies 22 to be designed can be kept in a specific range, so that the width of the silicon oxide columnar bodies 22 can be kept within a constant range. Thus, the yield of the metalens 100 can be improved.

$${φ}^{′} ( r ) = φ ( r ) - 360 ° \times n \qquad ( A )$$

$${φ}^{′} ( r ) < 360 ° \qquad ( B )$$

### Columnar Body Dimension Determination Step S11

In the columnar body dimension determination step S11, the relationship between the height H, the width aₓ, and the period Λₓ of the silicon oxide columnar bodies 22 constituting the metalens 100 and the phase difference is calculated to determine the ranges of the height H and the width aₓ, and the period Λₓ of the silicon oxide columnar bodies 22. For example, Rigorous Coupled Wave Analysis can be used to calculate the relationship between the width aₓ, a center-to-center distance (period) Λₓ, and the height H of the silicon oxide columnar bodies 22 and the phase difference. Here, a method of adjusting the distribution of the equivalent refractive index n_{2D} by fixing the period Λₓ and the height H of the silicon oxide columnar bodies 22 and changing the widths of the silicon oxide columnar bodies 22 will be described, but the present invention is not limited thereto.

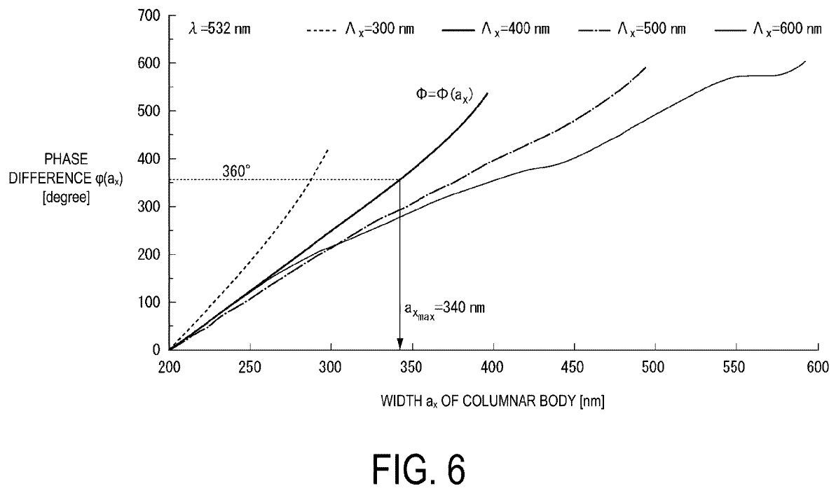

The height H of each of the silicon oxide columnar bodies 22 is fixed, the width aₓ of the silicon oxide columnar body 22 serving as a reference is set as a lower limit, the period Λₓ is fixed, and the phase difference φ(aₓ) with respect to the width aₓ of the silicon oxide columnar body 22 is calculated. The width aₓ of the silicon oxide columnar body 22 serving as a reference may be the width of the smallest silicon oxide columnar body 22 that can be formed. The phase difference φ(aₓ) with respect to the width aₓ of the silicon oxide columnar body 22 is calculated for each period Λₓ. FIG. 6 shows an example of a calculation result of the phase difference φ(aₓ) for each period Λₓ with respect to the width aₓ of the silicon oxide columnar body 22, when the height H of the silicon oxide columnar body 22 is 2.5 μm and the wavelength of the incident light is 532 nm. In FIG. 6, the horizontal axis represents the width aₓ (nm) of the silicon oxide columnar body 22, and the vertical axis represents the phase difference φ(aₓ) (°). The phase difference φ(aₓ) is calculated by subtracting a phase value of aₓ serving as the lower limit, from the phase value at each width aₓ. In FIG. 6, when the period Λₓ is 400 nm, the phase difference can be controlled in a range from 0 to 360° by setting the width aₓ of the silicon oxide columnar body 22 in a range from 192 nm to 340 nm. Thus, it is preferable to set the period Λₓ so that the phase difference φ(aₓ) is in the range from 0 to 360°.

Further, as shown in FIG. 6, it is not possible to increase the width aₓ of the columnar body to a value larger than the value of the period, and thus, if the height is high, the aspect ratio is large. Accordingly, there is a great merit in providing the metalens 100 having an aspect ratio of greater than 6.7 according to the present invention.

Columnar Body Width with Respect to Distance r Calculation Step

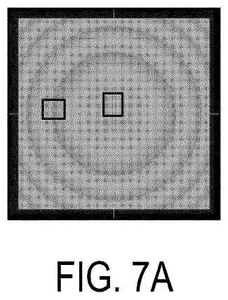

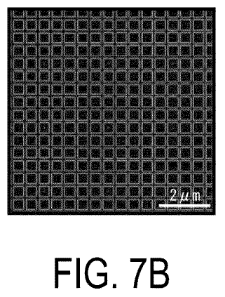

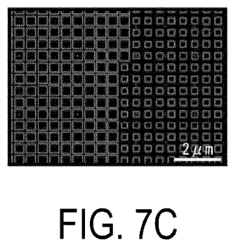

In the columnar body width with respect to distance r calculation step S12, the width of each of the columnar bodies with respect to the distance r from the center of the metalens is calculated from the relationship between the phase difference φ(r) with respect to the distance r and the phase difference φ(aₓ) with respect to the width aₓ of the silicon oxide columnar body 22. The metalens 100 is designed by using the phase difference φ(r) with respect to the distance r from the lens center and the phase difference φ(aₓ) with respect to the width aₓ of the silicon oxide columnar body 22. Specifically, the phase difference φ(r) at the distance r is replaced with the width aₓ of the silicon oxide columnar body 22 corresponding to the phase difference. Therefore, the width aₓ of the silicon oxide columnar body 22 with respect to the distance r from the center of the metalens can be obtained, and the metalens 100 can be designed. FIG. 7A is an example of a pattern model of a designed metalens. FIG. 7B is an enlarged view of the vicinity of the center of the metalens in FIG. 7A. FIG. 7C is an enlarged view of the vicinity of a boundary where the width of the silicon oxide columnar bodies 22 of the metalens changes. From FIG. 7, it can be understood that the phase difference @ is changed by changing the width aₓ. FIG. 7B illustrates a lens center portion, where the phase difference does not vary significantly depending on the location. Therefore, the width aₓ also substantially does not vary, and columnar bodies having substantially the same dimensions are two-dimensionally and periodically arrayed. FIG. 7C illustrates the above-described folding portion in which the phase is 360°, and a boundary portion between the width aₓ having a phase of 360° and the width aₓ in which the folding is 22 is visible. In FIG. 7C, the width aₓ varies largely before and after the folding. However, the phases are at 360° and at a portion corresponding to 0° of folding, so that the phases are continuously connected.

### Correction Step S31

In a method of manufacturing the metalens 100 described below, a silicon layer is subjected to electron beam lithography and silicon dry etching to form a silicon columnar body, and then, the silicon columnar body is oxidized. The silicon columnar body expands in the oxidation, so that the measured value of the silicon oxide columnar body 22 after oxidation deviates from the set value. Therefore, it is preferable to correct the set value of the silicon columnar body before oxidation, based on the actual measurement value of the width of the silicon oxide columnar body 22.

The correction step S31 of correcting the set value will be described below. The correction step S31 includes a columnar body width measurement step S13 of preparing a metalens of silicon columnar bodies having a predetermined width and measuring the width aₓ of each of the silicon oxide columnar bodies 22 of the obtained metalens, a prediction function creation step S14 of creating, after the width is measured, a prediction function for predicting an actual measurement value of each of the silicon oxide columnar bodies 22 with respect to a design value of the silicon oxide columnar body before oxidation from a set value of the width of the silicon oxide columnar body 22 and an actual measurement value of the width of the silicon oxide columnar body 22, and a feedback function creation step S15 of correcting the set value of the silicon columnar body by creating a feedback function for performing calculation by using the obtained prediction function, so that the set value of the silicon oxide columnar body 22 is obtained from the actual measurement value of the silicon oxide columnar body 22. Each step will be described below.

### Columnar Body Width Measurement Step

In the columnar body width measurement step S13, a metalens is prepared based on the design of a silicon columnar body having a predetermined width, and the width aₓ of the silicon oxide columnar bodies 22 of the obtained metalens is measured. For example, the width aₓ can be measured from an observation image observed by using a scanning electron microscope.

### Creation of Prediction Function

In the prediction function creation step S14, after the measurement step S13 of the width aₓ of the silicon oxide columnar bodies 22, a prediction function for predicting the actual measurement value of the width with respect to the design value of the silicon oxide columnar body is created from an original set value of the width of the silicon oxide columnar bodies 22 and the actual measurement value of the width of the silicon oxide columnar bodies 22. A method of creating the prediction function is not particularly limited. For example, the prediction function may be created by performing linear approximation from a ratio between the actual measurement value and the set value of each of the silicon oxide columnar bodies 22 (actual measurement value/set value) and the set value of the width of the silicon oxide columnar body 22.

### Creation of Feedback Function

In the feedback function creation step S15, the set value of the silicon oxide columnar body is corrected by creating a feedback function for performing calculation by using the prediction function obtained in the prediction function creation step S14, so that the set value of the silicon oxide columnar body 22 is obtained from the actual measurement value of the silicon oxide columnar body 22. The feedback function is created by solving the prediction function in reverse. The feedback function is a function that returns the width of the design value of the silicon columnar body with respect to the desired silicon oxide columnar body 22. The feedback function is created, and an initial width of the silicon columnar body is designed and corrected so that the silicon oxide columnar body takes a set value.

In the above description, the feedback function is obtained by preparing a metalens and measuring the width aₓ of each of the silicon oxide columnar bodies 22 of the obtained metalens. However, the feedback function may be obtained by preparing only silicon columnar bodies having various widths and shapes, without preparing a metalens, actually measuring a width of silicon oxide columnar bodies obtained by oxidizing the silicon columnar bodies, and obtaining a deviation from a set value. It is desirable to prepare a metalens because in this case, the influence of the surroundings can be taken into consideration during the oxidation. However, it takes time and effort to prepare the metalens. On the other hand, when only the silicon columnar bodies are prepared, it is easy to grasp the expansion due to unprecise oxidation.

The influence of the deviation from the design value due to oxidation can be reduced after the oxidation treatment by using the obtained feedback function to form the silicon columnar body thinner than the set width in the stage of the design width, in consideration of the expansion due to oxidation.

A method of designing the metalens 100 according to the present disclosure has been described above. According to the method of designing the metalens 100 according to the present disclosure, the width of each of the columnar bodies of the metalens 100 can be kept within a predetermined range, and the yield of the metalens 100 can be improved. Furthermore, the deviation from the design value due to the influence of oxidation is corrected, based on the actual measurement value, and thus, it is possible to further improve the light collection property.

In the method of designing a metalens according to the present disclosure, the prediction function and the feedback function are created. However, the prediction function and the feedback function may not be created.

### Method of Manufacturing Metalens

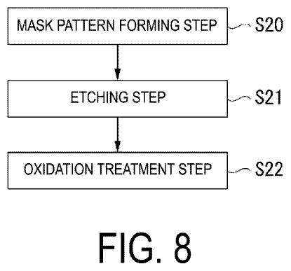

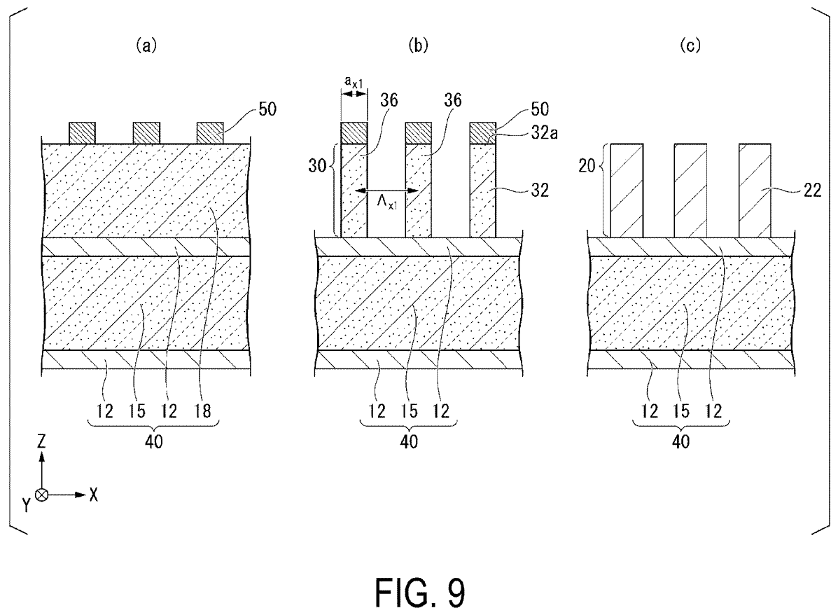

Next, a method of manufacturing the metalens 100 will be described. FIG. 8 is a flowchart illustrating a method of manufacturing the metalens 100 according to the first embodiment. FIGS. 9(a) to 9(c) are cross-sectional views illustrating an example of manufacturing steps in the method of manufacturing the metalens 100 in FIGS. 1(a) and 1(b). The method of manufacturing a metalens according to the first embodiment includes a mask pattern forming step S20 of forming a mask pattern 50 on a silicon layer 18 of a substrate 40 provided with the silicon layer 18 on a surface thereof, an etching step S21 of etching the silicon layer 18 to form a silicon pattern layer 30 having an array pattern (silicon array pattern) 36 composed of a plurality of silicon columnar bodies 32, and an oxidation treatment step S22 of oxidizing at least a part of the silicon in the silicon pattern layer 30 to form the pattern layer 20 composed of a plurality of silicon oxide columnar bodies 22.

### Mask Pattern Forming Step S20

In the mask pattern forming step S20, the mask pattern 50 is formed on the silicon layer 18 of the substrate 40 (FIG. 9(a)). The thickness and the material of the mask pattern 50 are not particularly limited, as long as the silicon pattern layer 30 can be formed after etching. The mask pattern 50 may be composed of a resin, silicon oxide, silicon nitride, or alumina. A formation method of forming the mask pattern 50 on the substrate 40 is not particularly limited. For example, when the mask pattern 50 is composed of a resist, the mask pattern 50 can be formed by a method described below, for example. A resist is applied to the substrate 40 and lithography (such as electron beam lithography, deep ultraviolet lithography, and nanoimprint lithography) is used to form a pattern. After the lithography, the pattern can be developed to form the mask pattern 50.

The mask pattern 50 may be formed of a metal. An example of a method of forming the mask pattern 50 when the mask pattern 50 is composed of a metal such as Cr will be described below. First, a metal such as Cr is deposited on the substrate 40 by vapor deposition or the like. Afterwards, a resist (resin) is applied onto the deposited metal. After applying the resist, lithography is used to form a pattern. Subsequently, the metal may be etched to form the mask pattern 50. By using a metal that is harder to be etched than the resist as the mask pattern 50, it is possible to prevent a surface 32a on a tip end side of each of the silicon columnar bodies 32 from being scraped during etching. Thus, the planar shape of the silicon columnar body 32 can be processed more precisely, and the difference between the designed optical characteristics and the optical characteristics of the metalens 100 can be reduced.

The configuration of the substrate 40 is not particularly limited, as long as the substrate 40 is provided with the silicon layer 18 on a surface thereof and can reflect incident light. In the first embodiment, the substrate 40 includes the support substrate 15, the intermediate layer 12 provided on the support substrate 15, and the silicon layer 18 provided on the intermediate layer 12. The material of the support substrate 15 is not particularly limited. For example, the material of the support substrate 15 is silicon. The material of the intermediate layer 12 is preferably a material having an etching rate lower than that of Si during etching. The material of the intermediate layer 12 is, for example, SiO₂. When the material of the intermediate layer 12 is a material having an etching rate lower than that of Si, such as SiO₂, etching in the intermediate layer 12 is suppressed, so that the height of the silicon columnar body 32 can be easily controlled. The thickness of the support substrate 15 is not particularly limited as long as the metalens 100 can function as the reflective type metalens 100. The thickness of the intermediate layer 12 is also not particularly limited as long as the metalens 100 can function as the reflective type metalens 100. For example, the thickness of the intermediate layer 12 is from 1 μm to 20 μm. The substrate 40 is, for example, a Silicon On Insulator (SOI) substrate.

The crystallinity of the silicon layer 18 is not particularly limited. The silicon layer 18 may be monocrystalline, polycrystalline, or amorphous. The silicon layer 18 is preferably monocrystalline.

The thickness of the silicon layer 18 can be appropriately set in accordance with the design of the metalens 100. For example, if the mask pattern 50 does not disappear during etching, the thickness of the silicon layer 18 is the height H of the silicon oxide columnar body 22. For example, the thickness of the silicon layer 18 is from 1.0 μm to 3.0 μm.

### Etching Step S21

In the etching step S21, the silicon layer 18 is etched to form the silicon pattern layer 30 having the array pattern 36 composed of the plurality of silicon columnar bodies 32 (FIG. 9(b)). In the etching step S21, the silicon pattern layer 30 may be etched by considering the expansion of silicon in the oxidation treatment step S22. Si has high etching selectivity, and thus, the silicon columnar bodies 32 having a high aspect ratio can be formed. The etching is preferably dry etching. The dry etching can be performed by a known method, for example, inductively coupled plasma etching. The etching is preferably performed by alternating between a passivation step for forming a blocking layer and an etching step for etching the silicon. Thus, the silicon columnar bodies 32 having a high aspect ratio can be formed. In the etching of the silicon, the silicon columnar bodies 32 are each formed with the width of the design value, based on the design value of the silicon columnar bodies 32 obtained from the feedback function. The silicon columnar bodies 32 are usually formed thinner than a set value, in consideration of the expansion in the oxidation treatment.

A center-to-center distance Λₓ1 in the X direction between the silicon columnar bodies 32 formed in the etching step S21 is preferably 1.4 times or more a width aₓ₁ of each of the silicon columnar bodies 32. More preferably, the center-to-center distance Λₓ₁ in the X direction between the silicon columnar bodies 32 is 1.6 times or more the width aₓ₁ of each of the silicon columnar bodies 32. When the silicon columnar body 32 is completely oxidized, the width of the silicon columnar body 32 is 1.4 times to 1.6 times the width aₓ₁, for example. Therefore, by setting the center-to-center distance Λₓ₁ in the X direction to 1.4 times to 1.6 times the width aₓ₁, it is possible to prevent the silicon oxide columnar bodies 22 from connecting to each other. Similarly, a center-to-center distance Λ_{y}1 between the silicon columnar bodies 32 in the Y direction is preferably 1.4 times or more a width a_{y1} of each of the silicon columnar bodies 32 in the Y direction. More preferably, the center-to-center distance Λ_{y1} between the silicon columnar bodies 32 in the Y direction is 1.6 times or more the width a_{y1} of each of the silicon columnar bodies 32.

### Oxidation Treatment Step S22

In the oxidation treatment step S22, after the mask pattern 50 is removed, at least a part of the silicon in the silicon pattern layer 30 is oxidized to form the pattern layer 20 composed of the plurality of silicon oxide columnar bodies 22 (FIG. 9(c)). The feedback function is taken into consideration, so that each of the formed silicon oxide columnar bodies 22 has a value close to the set value. The pattern layer 20 composed of the silicon oxide columnar bodies 22 has a focal point for light incident on the pattern layer 20. By oxidizing the silicon columnar bodies 32 to form the silicon oxide columnar bodies 22, columnar bodies composed of SiO₂ having a high aspect ratio can be formed without being damaged. A method of oxidizing the silicon is not particularly limited. Thermal oxidation is preferred as the oxidation method. Examples of the thermal oxidation method include dry oxidation, wet oxidation, and steam oxidation. Among these, dry oxidation and wet oxidation are preferred. Wet oxidation is particularly preferred. By oxidizing the silicon columnar bodies 32 by wet oxidation, the silicon oxide columnar bodies 22 can be formed in a short time.

The temperature during oxidation is not particularly limited, and is, for example, from 800° C. to 1150° C. The time for oxidizing the silicon pattern layer 30 can be appropriately set. The silicon in the silicon pattern layer 30 may be entirely SiO₂. If the silicon in the silicon pattern layer 30 is entirely SiO₂, the transmittance of the pattern layer 20 can be improved.

A method of manufacturing a metalens according to the present embodiment has been described above. According to the method of manufacturing a metalens according to the first embodiment, a columnar body of SiO₂ having a high aspect ratio can be formed. Therefore, it is possible to manufacture the metalens 100 having a short focal length.

The method of manufacturing a metalens according to the first embodiment may include, after the etching step S21, a step of annealing the substrate provided with the silicon pattern layer 30 in a hydrogen atmosphere, an argon atmosphere, or a mixed atmosphere of hydrogen and argon. After the etching step S21, hydrogen-annealing, argon-annealing, or annealing in a mixed gas of hydrogen and argon is performed to reduce the unevenness of the side surface of each of the silicon columnar bodies 32. For example, the hydrogen annealing, argon annealing, or annealing in a mixed gas of hydrogen and argon can be performed in an atmosphere containing 100% hydrogen, 100% argon, or a mixed gas of hydrogen and argon at a temperature of 800° C. to 1200° C.

### Second Embodiment

The support substrate 15 of the metalens according to the first embodiment may be a transparent substrate (for example, silicon dioxide (SiO₂)). Thus, the metalens 100 according to the second embodiment can be a transmissive metalens that transmits incident light.

In this case, the intermediate layer 12 may be provided as a transparent layer or the intermediate layer 12 may not be provided.

In the manufacturing, SiO₂ which is transparent, may be used for the support substrate 15 from the beginning.

The metalens 100 according to the second embodiment may be warped.

### Third Embodiment

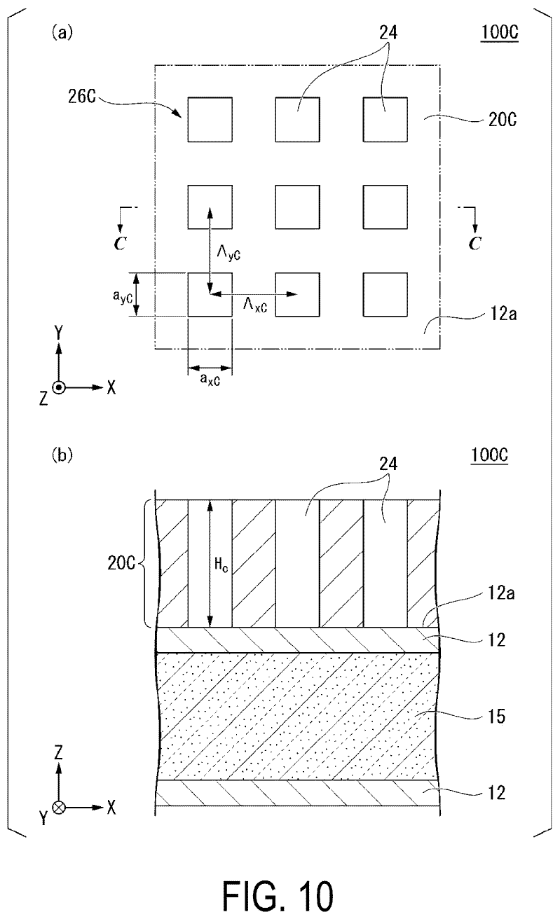

A metalens according to a third embodiment of the present invention will be described below. FIG. 10(a) is a plan view in which a part of an array pattern of a metalens 100C according to the third embodiment is enlarged. FIG. 10(b) is a cross-sectional view taken along line C-C of the metalens 100C in FIG. 10(a). The metalens 100C includes the support substrate 15 and a pattern layer 20C, in this order. The pattern layer 20C has an array pattern 26C composed of a plurality of holes 24. The metalens 100C according to the third embodiment is a reflective type metalens that reflects incident light.

### Pattern Layer 20C

In the third embodiment, the pattern layer 20C is provided on the intermediate layer 12. The pattern layer 20C has the array pattern 26C composed of the plurality of holes 24. Here, the array pattern 26C is a pattern in which fine structured bodies (the holes 24 in the case of the third embodiment) are regularly arranged in the X direction and the Y direction at predetermined intervals. The pattern layer 20C contains at least SiO₂. The pattern layer 20C may contain Si.

The shape (planar shape) of each of the holes 24 viewed from the Z direction is not particularly limited, and may be a polygon, a circle, or the like. In the third embodiment, the planar shape of the hole 24 is a square. A width axe in the X direction and a width aye in the Y direction of the hole 24 are appropriately set in accordance with the design of the metalens 100C. For example, the width a_{xc} of the hole 24 in the X direction is from 150 nm to 600 nm. The width a_{yc} of the hole 24 in the Y direction is, for example, from 150 nm to 600 nm.

A center-to-center distance (period) Λ_{xc} along the X direction of the holes 24 viewed from the Z direction and a center-to-center distance (period) Λ_{yc} along the Y direction of the holes 24 viewed from the Z direction are appropriately set in accordance with the design of the metalens 100C. For example, the period Λ_{xc} of the holes 24 along the X direction is from 200 nm to 600 nm. The period Λ_{yc} of the holes 24 along the Y direction is, for example, from 200 nm to 600 nm. The period Λ_{xc} and the period Λ_{yc} are preferably the same. When the planar shape (outer shape) of each of the holes 24 is a polygon, the center of the hole 24 viewed from the Z direction is the center of the smallest enclosing circle, and is the center of a circle when the planar shape (outer shape) of the hole 24 is a circle.

A length (depth) Hc of the hole 24 in the Z direction is appropriately set in accordance with the design of the metalens 100C. The depth Hc of the hole 24 is from 1.0 μm to 3.0 μm.

The aspect ratio (Hc/a_{xc}), which is the ratio between the depth Hc of the hole 24 and the width a_{xc} of the hole 24 in the X direction, is appropriately set in accordance with the design of the metalens 100C. The maximum value of the aspect ratio (Hc/a_{xc}) is greater than 6.7. The maximum value of the aspect ratio (Hc/a_{xc}) is more preferably 7.0 or greater. Similarly, the maximum value of the aspect ratio (Hc/a_{y}), which is the ratio between the depth Hc of the hole 24 and the width a_{yc} of the hole 24 in the Y direction, is also appropriately set in accordance with the design of the metalens 100C. The maximum value of the aspect ratio (Hc/a_{yc}) is greater than 6.7. The maximum value of the aspect ratio (Hc/a_{yc}) is more preferably 7.0 or greater. When the planar shape of the hole 24 is a square or a circle, the aspect ratio (Hc/a_{xc}) is substantially the same as the aspect ratio (Hc/a_{yc}). That is, in this case, the aspect ratio of the hole 24 is the ratio between the width and the depth.

As described above, the metalens 100C according to the present embodiment has been described. The aspect ratio of the hole 24 is high, and thus, the focal length of the metalens 100C can be shortened to a value from 500 μm to 2500 μm.

The metalens 100C is a reflective type lens. However, if a transmissive substrate is used for the substrate, a metalens of transmissive type can be formed.

In the third embodiment, the metalens 100C includes the intermediate layer 12. However, the metalens 100C may not include the intermediate layer 12 as long as the metalens 100C can reflect incident light.

The metalens 100C according to the third embodiment may be warped.

The same manufacturing method as in the first embodiment may be used to manufacture the metalens 100C according to the third embodiment, except that a portion other than portions forming the holes 24 is covered with a mask pattern and etched to form the holes 24 having a high aspect ratio.

### First Modification

As a modification of the metalens according to the first embodiment, the shape (planar shape) of each of the silicon oxide columnar bodies 22 may be circular. Even if the shape of the silicon oxide columnar body 22 is circular, the metalens can be caused to function as a metalens by adjusting the occupancy rate fₓ or the like.

The metalens, the method of designing a metalens, and the method of manufacturing a metalens according to the present embodiment have been described in detail above. Note that the technical scope of the present invention is not limited to the above-described embodiments, and various modifications can be made without departing from the gist of the present invention. In addition, it is possible to appropriately replace the constituent elements in the above-described embodiments with well-known constituent elements without departing from the gist of the present invention, and the above-described modification may be appropriately combined. The metalens according to the present embodiment may be mounted in an electronic device. Examples of the electronic device equipped with the metalens according to the present embodiment include a mobile phone.

### EXAMPLES

Next, Examples of the present invention will be described. However, the conditions in the Examples are examples of the conditions adopted for confirming the practicability and effects of the present invention, and the present invention is not limited to these examples of conditions. The present invention can employ various conditions as long as the object of the present invention is achieved without departing from the gist of the present invention.

### Example 1

The focal length was 1000 μm and the wavelength was 532 nm. The metalens 100 was designed by the method described in the method of designing the metalens 100 described above. The height H of each of the columnar bodies was 2.5 μm, the period of the columnar bodies was 400 nm, and the width of each of the columnar bodies was from 192 nm to 340 nm, so that the phase difference was in a range from 0 to 360°. The width of the columnar bodies at each position was determined from the phase difference and the distance r from the lens center in FIG. 5, to design a metalens such as illustrated in FIG. 7A. Note that the metalens of the Example was manufactured in the form of a cylinder, instead of a quadrangular prism.

### Manufacturing of Reflective Type Metalens

A 20 mm square SOI substrate was used. The thickness of a handle layer (Si) was 525 μm and the crystal orientation of the handle layer (Si) was (111), the thickness of a box layer (SiO₂) was 4 μm, and the crystal orientation of a device layer (Si) was (111). Electron beam (EB) resist (ZEP520A, manufactured by Zeon Corporation) and ESPACER solution were spin-coated on the device Si surface layer to form a film. The thickness of the resist film was about 140 nm.

EB lithography was performed by using an EB lithography apparatus JBX-6300SK manufactured by JEOL Ltd. After performing EB lithography, the obtained product was developed. Pure water was used for removing the ESPACER solution, ZED-N50 manufactured by Zeon Corporation was used as a developer solution for the resist, and isopropyl alcohol (IPA) was used for removing the developer solution.

In the dry etching, an inductively coupled plasma (ICP) etching apparatus MUC-21 manufactured by SPP Technologies Co., Ltd. was used. One cycle of the etching consisted of passivating with C₄F₈ gas for 2.5 seconds and then, etching with SF₆ gas for 3 seconds. The cycle was repeated for 20 cycles to process the Si columnar bodies.

After the etching, acetone was used for ultrasonic cleaning for 15 minutes, IPA was used for rinsing, and a hot plate was used for drying the obtained product at 110° C. for 15 minutes.

The substrate on which the Si columnar bodies were formed was subjected to wet oxidation using a thermal oxidation furnace. The substrate was oxidized at an oxidation temperature of 1100° C., to prepare a metalens. The oxidation was performed under two conditions, that is, one hour and three hours.

### Expansion Rate of Width of Columnar Body

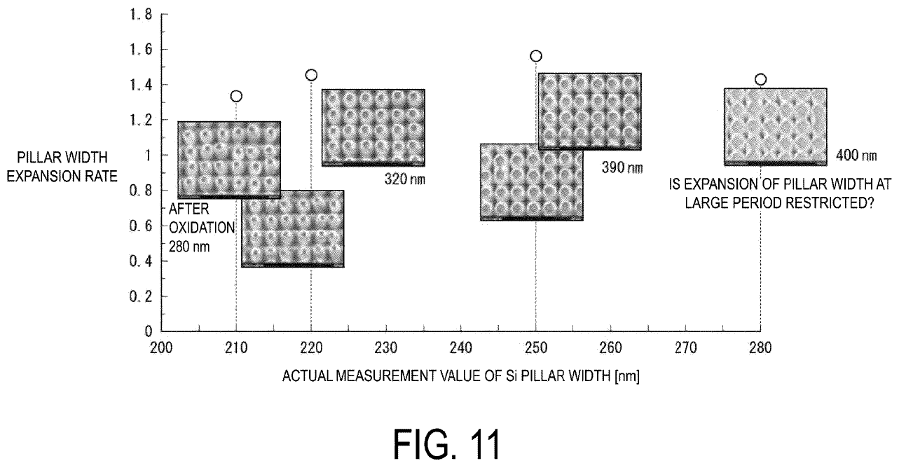

The silicon columnar body before oxidation and the silicon oxide columnar body after oxidation were observed with a scanning electron microscope (SEM) SU-70 manufactured by Hitachi High-Tech Corporation, to confirm the expansion rate of the width of the columnar body. FIG. 11 shows a relationship between the width (nm) of the obtained silicon columnar body and the expansion rate of the width of the columnar body after oxidation. In FIG. 11, the horizontal axis represents the width (nm) of the silicon columnar body (actual measurement value of Si pillar width), and the vertical axis represents the expansion rate (width after oxidation/width before oxidation) of the width of the columnar body (pillar width).

As shown in FIG. 11, the expansion rate indicates a tendency of increase in accordance with the width of the pillar. In a range from 200 to 280 nm, the expansion rate of the width of the columnar body was from 1.4 times to 1.6 times.

### Evaluation of Focal Length

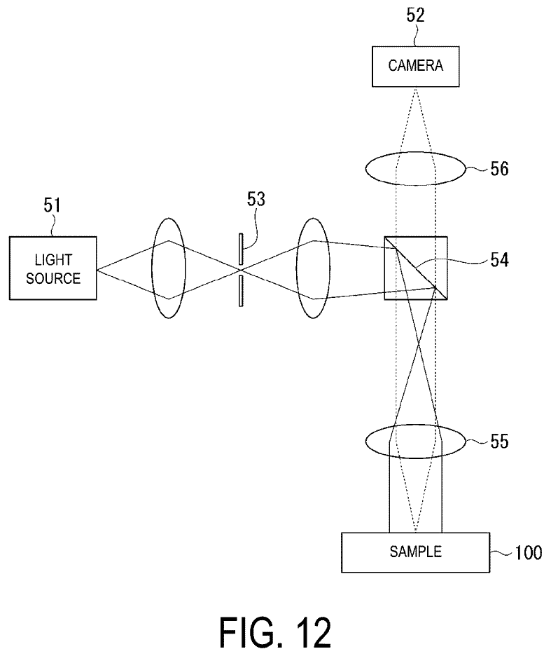

FIG. 12 is a schematic view of a focal length evaluation apparatus. A solid line represents an optical path of light emitted from a light source 51, and a dashed line represents an optical path observed by a camera 52. The emitted light does not form an image on the surface of the metalens and forms parallel light that irradiates the metalens. The camera 52 can be used to confirm whether an image is formed on the surface of the metalens 100 irradiated with light. The amount of light emitted from the light source 51 is reduced by an aperture diaphragm 53. The orientation of the light from the light source is changed towards the metalens 100 by a half mirror 54, and then, the light from the light source is collected on the surface of the metalens 100 by a condenser lens 55. An image on the surface of the metalens 100 is converted into parallel light by an objective lens 55, the light is directed to the camera 52, and an image is formed via a lens 56. Thus, the focal length can be evaluated.

First, the sample (the metalens) was placed on a stage and the focus was adjusted to the surface of the device layer. This location was used as a reference of 0 μm of the stage height. Subsequently, in order to sharpen the contour of a diaphragm image as much as possible, the aperture diaphragm was narrowed as much as possible. Images were repeatedly captured by lowering the stage while confirming the height using a micrometer. The captured images were evaluated by an image processing software. The evaluation being performed was a luminance distribution evaluation, and the luminance distribution with respect to the distance from the center of the metalens was analyzed from the captured image. The luminance value was calculated from RGB values of the obtained image data using Equation (7) below. Note that RGB refers to a red color component (R), a green color component (G) and a blue color component (B).

$$[ Math . 3 ]$$

$$V = \frac{R + G + B}{3} \qquad ( 7 )$$

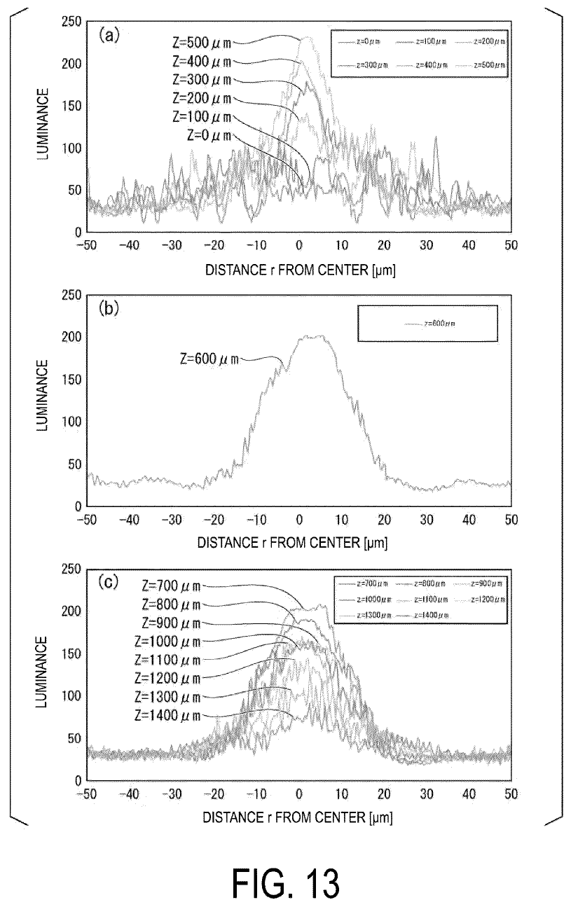

FIG. 13 shows a relationship between the luminance and the distance r from the lens center, measured while changing the height of the metalens during one hour of oxidation. The value of Z in each graph in FIG. 13 indicates the distance (μm) by which the stage is lowered. FIG. 13(a) shows the relationship between the luminance and the distance r from the lens center from Z=0 μm to Z=500 μm. The horizontal axis of FIG. 13(a) represents the distance r from the lens center, and the vertical axis represents the luminance. FIG. 13(b) shows the relationship between the luminance and the distance r from the lens center at Z=600 μm. The horizontal axis of FIG. 13(b) represents the distance r from the lens center, and the vertical axis represents the luminance. FIG. 13(c) shows the relationship between the luminance and the distance r from the lens center from Z=700 μm to Z=1400 μm. The horizontal axis of FIG. 13(c) represents the distance r from the lens center, and the vertical axis represents the luminance. In a metalens oxidized for one hour, the maximum luminance was obtained at Z=500 μm. The tail of the luminance distribution widened at Z=600 μm, and the luminance decreased from Z=700 μm to 1400 μm.

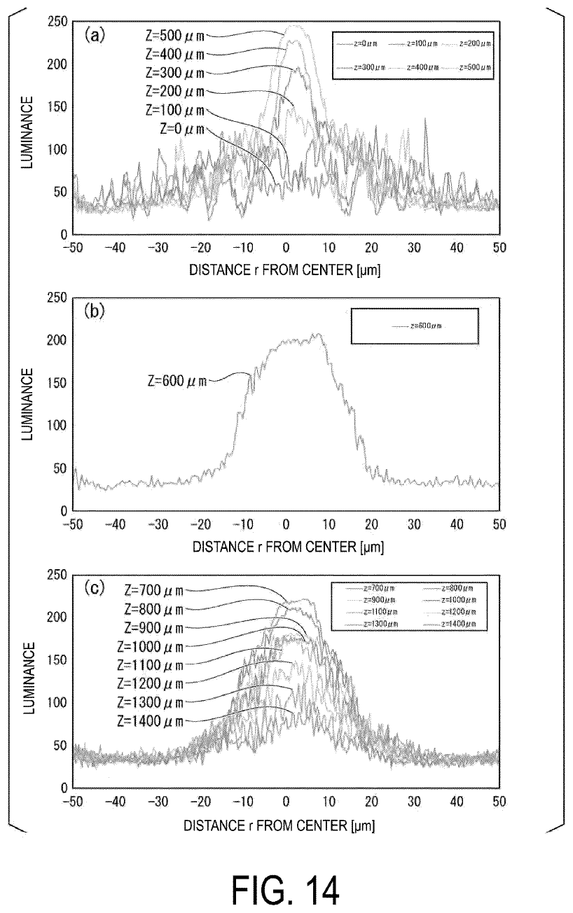

FIG. 14 shows a relationship between the luminance and the distance r from the lens center, measured while changing the height of the metalens during three hours of oxidation. The value of Z in each graph in FIG. 14 indicates the distance (μm) by which the stage is lowered. FIG. 14(a) shows the relationship between the luminance and the distance r from the lens center from Z=0 μm to Z=500 μm. The horizontal axis of FIG. 14(a) represents the distance r from the lens center, and the vertical axis represents the luminance. FIG. 14(b) shows the relationship between the luminance and the distance r from the lens center at Z=600 μm. The horizontal axis of FIG. 14(b) represents the distance r from the lens center, and the vertical axis represents the luminance. FIG. 14(c) shows the relationship between the luminance and the distance r from the lens center from Z=700 μm to Z=1400 μm. The horizontal axis of FIG. 14(c) represents the distance r from the lens center, and the vertical axis represents the luminance. In a metalens oxidized for three hours, the maximum luminance was obtained at Z=500 μm. The tail of the luminance distribution widened at Z=600 μm, and the luminance decreased from Z=700 μm to 1400 μm. The luminance after three hours of oxidation was higher. It is presumed that this is because the proportion of SiO₂ in the columnar body improves and a phase change due to dimensional expansion caused by the oxidation appears as a luminance change. The height of the actually obtained columnar bodies was 1521 nm, and the width of the silicon oxide columnar bodies was from 200 nm to 350 nm. It was confirmed that, in the metalens oxidized for three hours, columnar bodies having a high aspect ratio (height/width) of 4.3 to 7.6 can be formed.

### Example 2

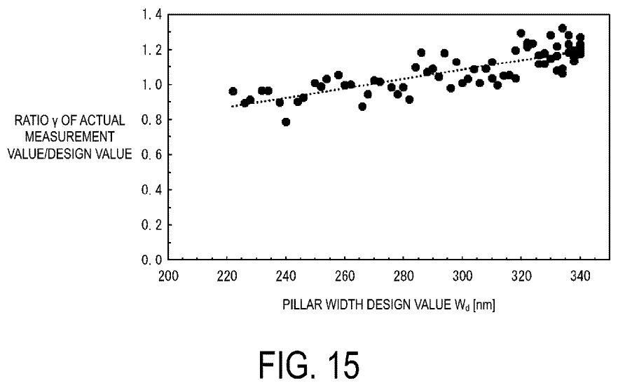

Next, a deviation of the actual measurement value from the design value of the width of the silicon oxide columnar bodies of the obtained metalens was corrected, and the metalens was prepared again. The deviation was corrected by the following procedure. First, the width of the silicon oxide columnar bodies of the metalens was measured by SEM. Next, an approximate expression of Equation (8) below was created by linear approximation from the design value of each of the columnar bodies and the ratio between the actual measurement value and the design value of the width of each of the obtained silicon oxide columnar bodies. FIG. 15 shows results of a linear approximation using a design value W_{d} of the columnar body and the ratio of an actual measurement value Wₘₚ and a design value W_{d} of the width of the silicon oxide columnar body. In FIG. 15, the horizontal axis represents the width (nm) of the columnar body, and the vertical axis represents the ratio between the actual measurement value of the width of the columnar body and the design value of the width (actual measurement value Wₘₚ/design value W_{d}). By multiplying both sides of the obtained Equation (8) by the design value W_{d} of the width of the columnar body, Equation (9) was obtained as a prediction function. Equation (10), which is a feedback function, was obtained by solving Equation (9) in reverse. In Equation (10), W_{d} is the design value before correction, and W_{df} is the design value after correction. Based on the correction, the width of each silicon oxide columnar body was corrected.

Next, based on the corrected design, a metalens according to Example 2 was prepared by using the same preparation method as in Example 1. In the metalens prepared in Example 2, light is primarily refracted at the pattern layer 20, passes through the intermediate layer (SiO₂ layer) 12, is reflected at the interface between the intermediate layer 12 and the support substrate 15, and is secondarily refracted again at the pattern layer 20. Therefore, the metalens was designed as a combined lens of two lenses, with a combined focal length (reflection focal length). In Example 2, the reflection focal length was 835 μm.

$$[ Math . 4 ]$$

$$γ = 0. 0027 {W}_{d} + 0 \text{.2816} \qquad ( 8 )$$

$${W}_{mp} = 0.0027 {W}_{d}^{2} + 0.2816 {W}_{d} \qquad ( 9 )$$

$${W}_{df} = \frac{- 0.2 \; 816 + \sqrt{{0.2816}^{2} + 4 \times 0.0027 \times {W}_{d}}}{2 \times 0.0027} \qquad ( 10 )$$

### Evaluation of Focal Length

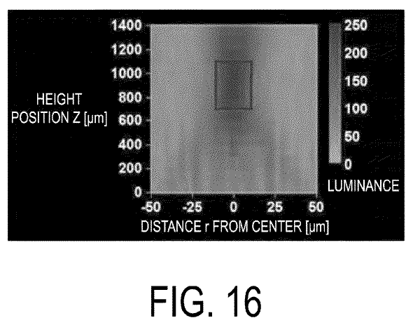

FIG. 16 illustrates a result of color mapping of the measurement result of the luminance for the metalens of Example 2. At a height position of Z=700-1100 μm, light concentrated in the vicinity of the center and high luminance was obtained (indicated by a frame in FIG. 16). Here, it was found that the manufactured metalens layer functioned as a light-collecting element. The overall luminance was also high. As a result of examining the luminance for each height position at r=0.101 μm in the vicinity of the center, the maximum luminance was obtained at Z=1000 μm, and the value thereof was the maximum value of 245, which is not illustrated in FIG. 16. At this position, the light was most strongly concentrated, and the focal length of the manufactured reflective type metalens was fREF=1000 μm. According to this result, the metalens and a metalens obtained by the method of manufacturing a metalens according to the present invention can be widely used in electronic devices (including machines and the like) using a lens, such as smartphones, VR glasses, microscopes, and cameras.

As described above, in the experiments according to the Examples, the embodiments of the present invention can provide a metalens having a short focal length and a method of manufacturing a metalens. In particular, it was confirmed that an excellent etching selectivity ratio of Si and a remarkable effect of converting Si into SiO₂ by thermal oxidation could be obtained.

A metalens, a method of manufacturing a metalens, an electronic device, and a method of designing a metalens according to the present embodiment have been described above. By using the metalens according to the present embodiment, the focal length can be shortened. Furthermore, according to the method of manufacturing a metalens and the method of designing a metalens according to the present embodiment, a metalens having a short focal length can be obtained.

### INDUSTRIAL APPLICABILITY

The metalens according to the present disclosure has a short focal length, and thus, wide industrial applicability.

### REFERENCE SIGNS LIST

12 Intermediate layer, 15 Support substrate, 20 Pattern layer, 22 Silicon oxide columnar body, 24 Hole, 100 Metalens

1. A method of manufacturing a metalens, the method comprising:
forming a mask pattern on a silicon layer of a substrate provided with the silicon layer on a surface;
etching the silicon layer to form a silicon pattern layer having an array pattern composed of a plurality of silicon columnar bodies or a plurality of pre-oxidation holes; and
performing oxidation on at least a part of silicon in the silicon pattern layer to form a pattern layer composed of a plurality of silicon oxide columnar bodies or a plurality of holes, wherein
the pattern layer has a focal point for light incident on the pattern layer.

2. The method of manufacturing a metalens, according to claim 1, wherein the oxidation is wet oxidation or dry oxidation.

3. The method of manufacturing a metalens, according to claim 1, the method further comprising:
after the etching,
annealing the substrate provided with the silicon pattern layer in a hydrogen atmosphere, an argon atmosphere, or a mixed atmosphere of hydrogen and argon.

4. The method of manufacturing a metalens, according to claim 1, wherein the mask pattern is composed of a resin, silicon oxide, silicon nitride, or alumina.

5. The method of manufacturing a metalens, according to claim 1, wherein the mask pattern is composed of a metal.

6. The method of manufacturing a metalens, according to claim 1, wherein a maximum value of an aspect ratio of the plurality of silicon oxide columnar bodies or the plurality of holes in the pattern layer is greater than 6.7.

7. The method of manufacturing a metalens, according to claim 1, wherein a center-to-center distance between the plurality of silicon columnar bodies is 1.4 times or more a width of the plurality of silicon columnar bodies.

8. The method of manufacturing a metalens, according to claim 1, wherein, in the etching, the silicon pattern layer is etched in consideration of an expansion of the silicon in the performing oxidation.

9. A metalens comprising, in this order:
a support substrate; and
a pattern layer having an array pattern composed of a plurality of silicon oxide columnar bodies or a plurality of holes, wherein
a maximum value of an aspect ratio of the plurality of silicon oxide columnar bodies or the plurality of holes in the pattern layer is greater than 6.7, and
at least surfaces of the plurality of silicon oxide columnar bodies or the plurality of holes of the pattern layer are SiO₂ obtained by oxidation of Si.

10. The metalens according to claim 9, wherein the pattern layer is composed of SiO₂.

11. The metalens according to claim 9, further comprising:
an intermediate layer between the support substrate and the pattern layer.

12. The metalens according to claim 9, wherein the pattern layer includes a folding portion at a location where a phase difference with respect to a center is 360°.

13. An electronic device comprising the metalens according to claim 9.

14. A method of designing a metalens, the method comprising:
performing phase difference calculation of calculating a phase difference φ(r) with respect to a distance r from a center of the metalens, based on a set wavelength λ and a set focal length f of incident light;
performing columnar body dimension determination of determining ranges of a height H and a width aₓ and a period Λₓ of silicon oxide columnar bodies included in the metalens by calculating a relationship between the height H, the width aₓ and the period Λₓ and a phase difference φ(aₓ) with respect to the width aₓ; and
after the performing columnar body dimension determination, performing columnar body width with respect to distance r calculation of calculating the width aₓ with respect to the distance r from the center of the metalens, from a relationship between the phase difference φ(r) with respect to the distance r and the phase difference φ(aₓ) with respect to the width aₓ, wherein
in the performing phase difference calculation, when the phase difference φ(r) with respect to the distance r is 360° or greater, φ′(r) is calculated satisfying Equation (A) and Expression (B) below to correct the width aₓ of the silicon oxide columnar bodies in consideration of an expansion of silicon due to oxidation:
$${φ}^{′} ( r ) = φ ( r ) - 360 ° \times n \qquad ( A )$$
$${φ}^{′} ( r ) < 360 ° \qquad ( B )$$
where in Equation (A), n is a natural number.

15. The method of manufacturing a metalens, according to claim 1, further comprising performing the method of designing a metalens, the method comprising:
performing phase difference calculation of calculating a phase difference φ(r) with respect to a distance r from a center of the metalens, based on a set wavelength λ and a set focal length f of incident light;
performing columnar body dimension determination of determining ranges of a height H and a width aₓ and a period Λₓ of silicon oxide columnar bodies included in the metalens by calculating a relationship between the height H, the width aₓ and the period Λₓ and a phase difference φ(aₓ) with respect to the width aₓ; and
after the performing columnar body dimension determination, performing columnar body width with respect to distance r calculation of calculating the width aₓ with respect to the distance r from the center of the metalens, from a relationship between the phase difference φ(r) with respect to the distance r and the phase difference φ(aₓ) with respect to the width aₓ, wherein
in the performing phase difference calculation, when the phase difference φ(r) with respect to the distance r is 360° or greater, φ′(r) is calculated satisfying Equation (A) and Expression (B) below to correct the width aₓ of the silicon oxide columnar bodies in consideration of an expansion of silicon due to oxidation:
$${φ}^{′} ( r ) = φ ( r ) - 360 ° \times n \qquad ( A )$$
$${φ}^{′} ( r ) < 360 ° \qquad ( B )$$
where in Equation (A), n is a natural number.
